(19) United States
(12) Patent Application Publication
(10) Pub. No.: US 2012/0043069 A1
(43) Pub. Date: Feb. 23, 2012

(54) DOWNHOLE WIRELINE WIRELESS COMMUNICATION

(75) Inventors: Christopher A. Maranuk, Houston, TX (US); Morris B. Robbins, Mandeville, LA (US)

(73) Assignee: Halliburton Energy Services, Inc.

(21) Appl. No.: 12/672,858

(22) PCT Filed: Aug. 28, 2007
(86) PCT No.: PCT/US07/18860

§ 371 Date: Sep. 21, 2011

(51) Int. Cl. E21B 43/00; G01V 1/40; G01V 3/00

(52) U.S. Cl. 166/66; 340/854.6; 340/853.9; 367/81; 175/327

(57) ABSTRACT

A drilling tool having memory to store measured data, a transceiver and an embedded antenna, where a transceiver is lowered into the bore of the drilling tool to receive a radio signal from the drilling tool transceiver to receive the stored measured data. Data may also be transmitted from the lowered transceiver to the drilling tool transceiver. Various methods may be employed to cause the transmitter to transmit the stored measured data while the drilling tool is still in the borehole. Other embodiments are described and claimed.

### FIELD

The present invention relates to oil and gas downhole technology, and more particularly, to wireless communication with down-hole drilling tools and drill strings.

### BACKGROUND

In the oil and gas exploration industry, downhole tools, such as measurement-while-drilling (MWD) tools, logging while drilling (LWD) tools, and rotary steerable drilling tools accumulate large amounts of data. Such measured data may be formation data, drilling data, directional data, and environmental data, to name a few examples. This data will eventually need to be read by equipment above ground. Because the telemetry data rate through a large volume of drilling mud is relatively slow, reading the accumulated data has involved bringing the tool above ground to the drilling platform, or bringing a reading device to the below-ground tool and making a wet connection.

Bringing a tool above ground can take time, which may be costly, especially in deep or problematic drilling environments. Wet connections to a below-ground tool rely on a physical connection in the drilling fluid (drilling mud), which may also be problematic. Furthermore, in some cases a tool may get stuck in a borehole, in which case it may be very difficult to retrieve the measured data from the tool by traditional surface-read means.

### BRIEF DESCRIPTION OF THE DRAWINGS

FIG. 1 illustrates a tool or drill string, and a downhole wireline, according to an embodiment of the present invention.

FIG. 2 illustrates a method according to an embodiment of the present invention.

FIG. 3 illustrates a method for use in smart wells according to the embodiment of the present invention.

### DESCRIPTION OF EMBODIMENTS

In the description that follows, the scope of the term “some embodiments” is not to be so limited as to mean more than one embodiment, but rather, the scope may include one embodiment, more than one embodiment, or perhaps all embodiments.

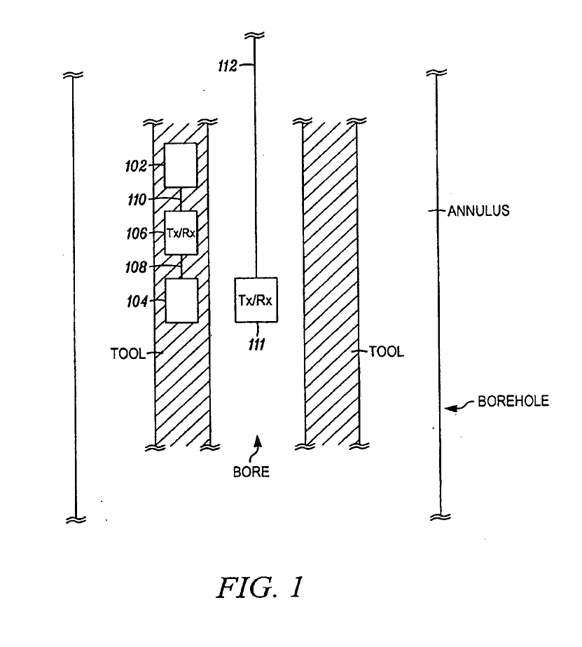

FIG. 1 illustrates a tool or drill string according to an embodiment of the present invention. (Embodiments may also be directed to smart casings.) For simplicity of illustration, some of the components in FIG. 1 are labeled by their common names. The illustration in FIG. 1 is pictorial in nature, and is not meant to delineate details of a drilling tool or drill string. FIG. 1 shows a portion of the tool or drill string cross-hatched in FIG. 1, inside a borehole. Skid devices for centering the tool or drill string within the borehole are not shown for simplicity. Drilling mud is present in the bore and the annulus, but is not illustrated for simplicity.

Measured data is stored in memory device 102. As is well known in the art of MWD and LWD, memory device 102 may comprise standard memory chips that are packaged to withstand the harsh environment encountered in the oil and gas industry. The embodiment illustrated in FIG. 1 has antenna 104 embedded in the tool. (For ease of discussion, the tool or drill string in FIG. 1 will be referred to simply as “tool”.) Antenna 104 is driven by tool transceiver 106 by way of transmission line 108. Tool transceiver 106 has access to data stored in memory device 102. For simplicity, memory device 102 is shown coupled to tool transceiver 106 by way of link 110, but in practice other interface components may be utilized, such as a memory controller or processor, for example.

Link 110 need not be a wired communication link. For example, link 110 may be an acoustic link, or a wireless link, such as for example an EM (Electromagnetic) short-hop link.

To access data stored in memory device 102, line transceiver 111 is lowered into the bore of the tool by line 112. Line 112 may be a wireline, for example, with one or more conductors to provide power to line transceiver 111 and to provide communication from line transceiver 111 to above-ground equipment. In other embodiments, line 112 may be a slickline, in which case line transceiver 111 comprises a power source and memory to store data, and the stored data may be recovered when line transceiver 111 is raised to the surface. For some embodiments, line 112 may also be an optical fiber.

To transfer data from the tool to line transceiver 111, digital data stored in memory 102 is provided to tool transceiver 106 for modulation to a radio frequency (RF) signal, whereupon the RF signal is transmitted by tool antenna 104 and is received by an antenna built into line transceiver 111. For other embodiments, the antenna coupled to line transceiver 111 may be part of line 112. Various well-known modulation formats may be utilized, and well-known communication protocols may be implemented. As just one example, the modulation format and protocols may be similar to, or a modified version of, the IEEE 802.11 standard.

Communication from tool transceiver 106 to line transceiver 111 may be initiated in various ways. Transceiver 111 may transmit a signal to the tool so that the tool begins transmission. In other embodiments, a transmitter on the surface may be used to transmit a low data rate signal to put tool transceiver 106 into a transmission mode. For such an approach, a radio receiver tuned to the carrier frequency of the low data rate signal may be embedded in the tool. Other embodiments may not have such a radio receiver in the tool, so that tool transceiver 106 may be caused to initiate transmission in other ways. For example, tool transceiver 106 may be programmed to initiate transmission at certain time intervals, at certain times, or at certain depths. A mud pulse may be transmitted through the mud when line transceiver 111 is lowered into a position nearby antenna 104, so that a sensor on the tool causes tool transceiver 106 to initiate transmission. Some embodiments may utilize rotation techniques, whereby a sudden change in torque or rotational speed of the drilling tool is sensed by a sensor on the tool to turn on tool transceiver 106. As another example, an acoustic signal may be transmitted down the drill pipe or drill string to initiate communication.

These embodiments of causing the tool to initiate transmission, other than utilizing transceiver 111, are described because, as discussed later, some embodiments may not have transceiver 111, but rather, the functional unit represented by 111 may be a receiver without the capability to transmit a signal to the tool.

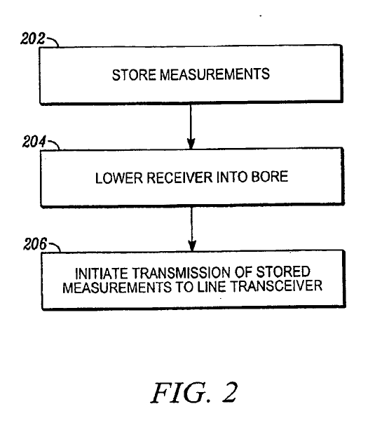

FIG. 2 illustrates a flow diagram according to an embodiment of the present invention. In block 202, measurement data is stored in memory 102. Such measurements data are well-known in the industry, and may include formation evaluation (e.g., gamma-ray, resistivity, nuclear, nuclear magnetic resonance, fluid sampling, and sonic, to name just a few), drilling (inclination, azimuth, rotational speed, vibration, rate of penetration, pressure, and weight on bit, to name just a few), tool dependent (tool serial numbers, part numbers, maintenance history, calibration history, to name just a few), or environmental data (e.g., temperature, vibration, shock, to name just a few). When the data is to be retrieved, block 204 indicates that a transceiver is lowered into the bore of the tool or drill string. In block 206, transmission is initiated, whereby a transceiver in the tool transmits the data to the line transceiver. As described earlier, the transmission may be initiated in a number of ways.

In another embodiment, the wireline transceiver may be used to send information from the surface through the downhole transceiver into the tool. This may be useful for downloading new tool settings, changing sampling rates and techniques, logic, re-initializing a downhole tool, changing or upgrading downhole software, reprogramming the downhole software, and turning off selected downhole sensors, to name just a few examples.

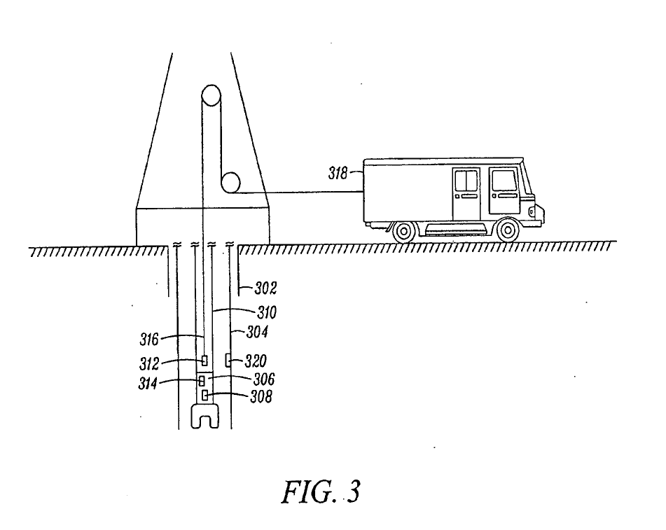

FIG. 3 illustrates, in simplified form, a well and accompanying infrastructure according to an embodiment. A well is shown with surface casing 302 and intermediate casing 304. For simplicity, not shown is various drilling equipment, such as a Kelly, drilling mud system, etc. Nearby drill collar 306 may include a number of sensors, represented by component 308, such as inclinometers and magnetometers, to measure directional parameters (e.g., inclination, azimuth), and other instruments to measure formation properties and drilling mud properties. Lowered into drill string 310 is transceiver 312, which communicates with tool transceiver 314. Transceiver 312 is lowered into drill string 310 using line 316, which may be, as discussed earlier, a wireline, slickline, fiber optical line, etc. In practice, transceiver 312 and line 316 would be hidden from view when looking from a position outside drillstring 310, but for ease of illustration solid lines are used to illustrate these components. Data received by transceiver 312 is communicated to surface computers in surface vehicle 318.

The well illustrated in FIG. 3 may also be a smart well. An intelligent, or smart well, is a well with downhole sensors that may measure well flow properties, such as for rate, pressure, and temperature, to name just a few examples. These sensors are collectively represented by sensor 320. In some circumstances, such if a communication link between smart well sensor 320 and the surface is down, transceiver 312 may be used to retrieve data collected by smart well sensor 320.

Various modifications may be made to the disclosed embodiments without departing from the scope of the invention as claimed below. For example, as discussed earlier, some embodiments may not incorporate a line transceiver, but rather, a line receiver. Some embodiments may not incorporate a tool transceiver, but rather, a tool transmitter. Generally, a transceiver is understood to comprise a transmitter and a receiver. Furthermore, it should be understood that a transceiver as depicted in FIG. 1 may be more general, in the sense that the transmitter and receiver are not physically integrated or co-located. That is, for example, some embodiments may have a physically separated transmitter and receiver, where each transmitter and receiver has a dedicate antenna.

What is claimed is:

1. An apparatus comprising:
a line;
an antenna; and
a receiver attached to the line and coupled to the antenna.

2. The apparatus as set forth in claim 1, wherein the line is any one of a wireline and a slickline.

3. The apparatus as set forth in claim 1, wherein the antenna is embedded in the wireline.

4. The apparatus as set forth in claim 1, further comprising a transmitter.

5. The apparatus as set forth in claim 4, wherein the transmitter and the receiver are integrated as a transceiver.

6. A system comprising:
a drilling apparatus having a bore and comprising
a memory to store measured data; and
a transmitter coupled to the memory;
a receiver; and
a line to suspend the receiver within the bore.

7. The system as set forth in claim 6, wherein the drilling apparatus is any one of a drilling tool and a drill string.

8. The system as set forth in claim 6, wherein the line is any one of a wireline and a slickline.

9. The system as set forth in claim 6, wherein the line is any one of a communication line to communicate with surface equipment and a non-communication line.

10. The system as set forth in claim 9, the drilling apparatus further comprising a link to couple the memory to the transmitter.

11. The system as set forth in claim 6, the line comprising an antenna.

12. The system as set forth in claim 6, further comprising a smart well having a sensor, wherein the receiver is in communication with the smart well sensor.

13. A method to retrieve stored measured data residing in memory in a drilling apparatus having a bore, the method comprising:
lowering a receiver into the bore of the drilling apparatus while the drilling apparatus is still in a borehole; and
causing a transmitter in the drilling apparatus to transmit to the receiver by way of an embedded antenna in the drilling apparatus a signal indicative of the stored measured data.

14. The method as set forth in claim 13, further comprising sending a mud pulse through drilling mud to cause the transmitter to transmit the signal.

15. The method as set forth in claim 13, further comprising programming the transmitter to transmit the signal.

16. The method as set forth in claim 13, further comprising changing a drilling parameter applied to the drilling apparatus to cause the transmitter to transmit the signal.

17. The method as set forth in claim 16, wherein the drilling parameter comprises torque, rotational speed, vibration, and rate of penetration.

18. The method as set forth in claim 13, further comprising sending an acoustic signal to the drilling apparatus to cause the transmitter to transmit the signal.

19. The method as set forth in claim 13, further comprising transmitting a signal to the drilling apparatus to cause the transmitter to transmit the signal.

20. The method as set forth in claim 13, wherein the receiver is lowered into the bore by way of a wireline, further comprising transmitting the stored measured data to a surface by way of the wireline.

21. The method as set forth in claim 13, wherein the receiver is lowered into the tool bore by way of an optical fiber line, further comprising transmitting the stored measured data to a surface by way of the optical fiber line.

22. The method as set forth in claim 13, further comprising raising the receiver out of the bore to retrieve the stored measured data.

23. The method as set forth in claim 13, further comprising transmitting the stored measured data to a surface.

24. The method as set forth in claim 13, further comprising transmitting data or commands from a surface to the drilling apparatus by lowering a second transmitter into the bore of the drilling apparatus while the drilling apparatus is still in the borehole.

25. The method as set forth in claim 13, the receiver comprising a transmitter to communicate with the drilling apparatus so that the drilling apparatus may communicate with the receiver.
